(19) United States
(12) Patent Application Publication
(10) Pub. No.: US 2019/0303083 A1
(43) Pub. Date: Oct. 3, 2019

(54) POWER SAVING ON SMART DISPLAY PANELS DURING WIRELESS DISPLAY SESSIONS

(71) Applicant: QUALCOMM Incorporated, San Diego, CA (US)

(72) Inventors: Jayant Shekhar, Hyderabad (IN); Raviteja Tamatam, Hyderabad (IN)

(21) Appl. No.: 15/944,369

(22) Filed: Apr. 3, 2018

(51) Int. Cl. G06F 3/147; G09G 5/393; G09G 5/00

(52) U.S. Cl. CPC G06F 3/147; G09G 5/393; G09G 5/006; G06F 3/04883; G09G 2360/127; G09G 2370/20; G09G 2370/16

(57) ABSTRACT

The techniques of this disclosure include initiating, by a source device associated with a primary display device, a wireless display session with an external display device. Furthermore, the source device may change from a dual update mode to an external-only update mode during the wireless display session. Based on the source device operating in the external-only update mode during the wireless display session, the source device may discontinue generation of the primary stream and may continue generation of the external stream.

### TECHNICAL FIELD

The present disclosure relates to display processing.

### BACKGROUND

Computing devices typically use display panels to output visual data. Display panels that implement a command mode display architecture may include on-panel memory which may store content to be displayed. The content may include a complete frame of image data. A display processor of a computing device that uses a display panel that implements a command mode display architecture may not be required to update the on-panel memory of the display panel with any particular timing scheme. Instead, a timing engine on a display panel that implements command mode display architecture may serve the frame stored in memory for display. In contrast, a display panel implementing a video mode display architecture may rely on the display processor to provide the display panel information in real-time. For instance, the display processor may provide a pixel data for a complete frame to the display panel once per refresh cycle of the display panel.

### SUMMARY

In accordance with various techniques of this disclosure, a computing device may send streams of pixel data to both a primary display panel and an external display panel. However, in accordance with one or more techniques of this disclosure, during the wireless display session, the computing device may discontinue the stream for the primary display device while continuing the stream for the external display device.

In one example, this disclosure describes a method for controlling streams of pixel data, the method including: initiating, by a source device associated with a primary display device, a wireless display session with an external display device; during the wireless display session, operating, by the source device, in a dual update mode; based on the source device operating in the dual update mode during the wireless display session: generating, by the source device, a primary stream of pixel data for display on the primary display device; and generating, by the source device, an external stream of pixel data for display on the external display device; changing, by the source device, from the dual update mode to an external-only update mode during the wireless display session; and based on the source device operating in the external-only update mode during the wireless display session: discontinuing, by the source device, generation of the primary stream such that the primary display device refreshes content displayed on the primary display device from pixel data stored in a memory included in the primary display device; and continuing, by the source device, generation of the external stream.

In another example, this disclosure describes a source device including: a transceiver; and one or more processing units configured to: initiate a wireless display session with an external display device; during the wireless display session, operate in a dual update mode; based on the source device operating in the dual update mode during the wireless display session: generate a primary stream of pixel data for display on a primary display device; generate an external stream of pixel data for display on the external display device; and send the external stream to the external display device via the transceiver; change the source device from the dual update mode to an external-only update mode during the wireless display session; and based on the source device operating in the external-only update mode: discontinue generation of the primary stream such that the primary display device refreshes content displayed on the primary display device from pixel data stored in a memory included in the primary display device; and continue generation of the external stream.

In another example, this disclosure describes a source device including: means for initiating a wireless display session with an external display device; means for generating, when the source device is in a dual update mode during the wireless display session, a primary stream of pixel data for display on a primary display device of the source device; means for generating, when the source device is in the dual update mode during the wireless display session, an external stream of pixel data for display on the external display device; means for changing the source device from the dual update mode to an external-only update mode during the wireless display session; and means for discontinuing, when the source device is in the external-only update mode during the wireless display session, generation of the primary stream such that the primary display device refreshes content displayed on the primary display device from pixel data stored in a memory included in the primary display device; and means for continuing, when the source device is in the external-only update mode during the wireless display session, generation of the external stream.

In another example, this disclosure describes a computer-readable storage medium having instructions stored thereon that, when executed, cause a source device to: initiate a wireless display session with an external display device; during the wireless display session, operate in a dual update mode; based on the source device operating in the dual update mode during the wireless display session: generate a primary stream of pixel data for display on a primary display device of the source device; and generate an external stream of pixel data for display on the external display device; change the source device from the dual update mode to an external-only update mode during the wireless display session; and based on the source device operating in the external-only update mode during the wireless display session: discontinue generation of the primary stream such that the primary display device refreshes content displayed on the primary display device from pixel data stored in a memory included in the primary display device; and continue generation of the external stream.

The details of one or more aspects of the present disclosure are set forth in the accompanying drawings and the description below. Other features, objects, and advantages of the present disclosure will be apparent from the description, drawings, and claims.

### BRIEF DESCRIPTION OF DRAWINGS

FIG. 1A is a block diagram illustrating an example of a video-mode display system.

FIG. 1B is a block diagram illustrating an example of a command-mode display system.

FIG. 2 is a block diagram illustrating an example system that includes a computing device, a primary display panel, and an external display panel that may be configured to implement one or more aspects of this disclosure.

FIG. 3 is a block diagram illustrating an example display stack in a computing device, in accordance with one or more aspects of this disclosure.

FIG. 4 is a flowchart illustrating an example operation of a source device, in accordance with one or more aspects of this disclosure.

FIG. 5 is a flowchart illustrating an example operation of a source device, in accordance with a technique of this disclosure.

### DETAILED DESCRIPTION

Smart display panels may include on-board memory (e.g., random access memory (RAM)) which may be used to refresh the display autonomously. In this disclosure, a smart display panel, or a system that includes a smart display panel, may be said to operate in a command mode. A smart display panel includes on-panel memory which may store a complete frame which a display processor is not required to update. In contrast, a “dumb” display panel may rely on a display processor to feed content to the display panel. In this disclosure, a “dumb” display panel may be said to operate in a video mode. In some examples, a smart display panel may also operate in the video mode.

When a computing device is using a smart display panel, a display processor of the computing device transmits a stream of pixel data to the smart display panel for storage in an on-board memory of the smart display panel. The display processor may be implemented in a central processing unit (CPU), graphics processing unit (GPU), a dedicated processor, or another type of component. In some examples, the display processor is a mobile display processor (MDP) designed to perform 2-dimensional (2D) operations on image data to be displayed. Example types of 2D operations include blending, compositing, overlay, rotating, upscaling, downscaling, and stretching. The display processor may not be required to supply data to the smart display panel at a constant rate as the smart display panel is refreshed from the on-board memory of the smart display panel.

In many circumstances, only a portion of the content displayed by a display panel is changing. For example, consider a webpage that includes a moving video while the rest of the webpage remains static. Thus, in this example, only the portion of the webpage with the video may need to be updated (i.e., redrawn). The use of a smart display panel may save costs associated with redundant data transfer when either a source refresh rate is lower than a display refresh rate or when only a portion of the display content has been redrawn. Such costs may include consumption of power, drain on a battery, memory usage, processor usage, consumption of bandwidth on a transmission path, and so on. A source refresh rate is a rate at which the display processor sends pixel data to a display panel. A display refresh rate is a rate at which a display panel refreshes what content is being displayed by the display panel. For example, when a computing device is using a smart display panel and a portion of the display content does not change, a display processor of the computing device may not need to resend the unchanged portions of the display content to the smart display panel because a copy of the unchanged portions of the display content is already stored in the on-board memory of the smart display panel. In this example, the smart display panel may continue using the copy of the unchanged changed portioned of the display content to output the display pixel data for display. Not resending the unchanged portions of the display content may reduce the amount of electrical energy consumed by the computing device. Additionally, not resending the unchanged portions of the display content may make more bandwidth available on a transmission path from the display processor to the smart display panel for portions of the display content that are changing. Because of the increased bandwidth in the transmission path, the smart display panel may able to receive updated display content more frequently, which may improve the experience for a user.

Wireless display is a technology that can include mirroring the content of a display of a source device on a display of an external display device. As used herein, the display of the source device is referred to as a “primary display” and the display of the external display device is referred to as a “sink display.” In example embodiments, the source device is a mobile device, such as a smartphone or tablet, and the external display device is a television, a projector, or a computer monitor. The source device may communicate with the external display device via a wireless technology, such as Wi-Fi.

When a computing device is engaged in a wireless display session, the computing device may generate two separate streams of pixel data: a primary stream for the primary display device and an external stream for the external display device. Each of the streams may include a series of pixel data sets. Each of the pixel data sets corresponds to a different frame. The source device may composite pixel data from one or more layers to generate a single pixel data set for either stream.

The techniques of this disclosure may reduce the energy consumption of the source device by discontinuing generation of the primary stream when certain mode change events occur during a wireless display session, such as when full-screen video content is being displayed. By discontinuing generation of the primary stream, the source device may avoid needing to perform layer compositing operations associated with generating the primary stream. Additionally, the source device may avoid electrical energy consumption associated with sending the primary stream to the primary display device and storing data associated with the primary stream. Discontinuing generation of the primary stream when full-screen video content is being displayed during a wireless display session may be acceptable to the user because the user is likely to be watching the full-screen video content on the typically-larger external display device. Moreover, video data displayed on the external display device may lag noticeably behind video data displayed on the primary display device.

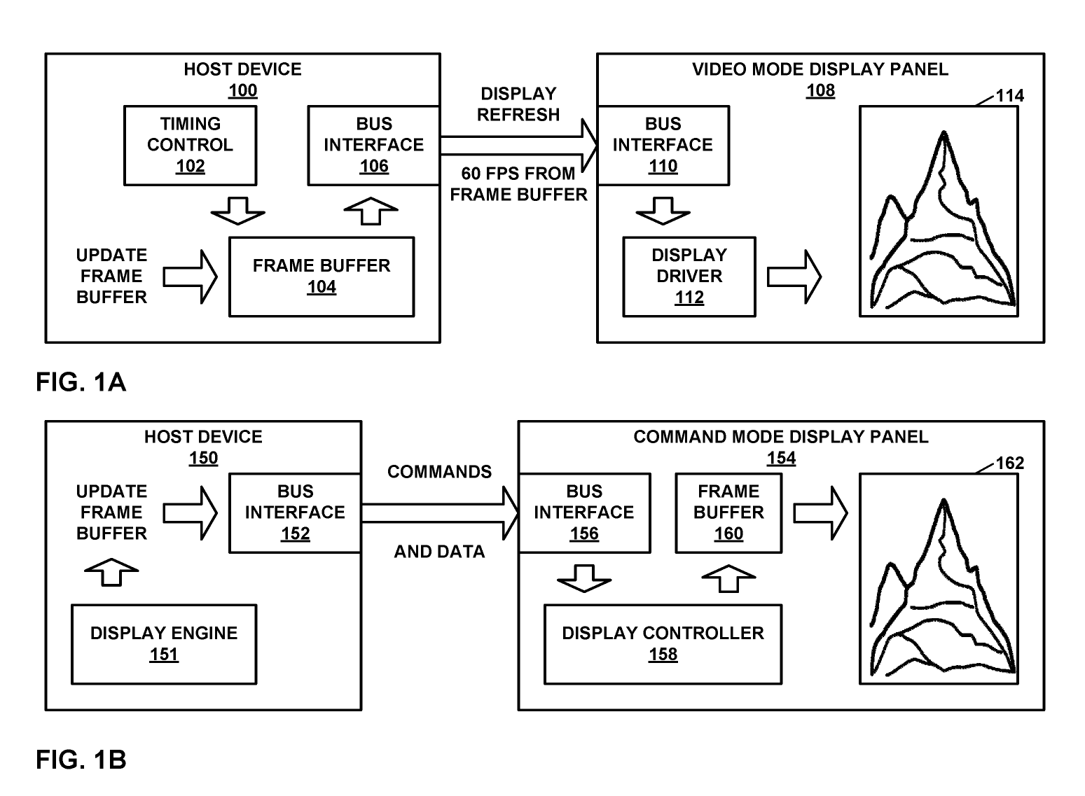

FIG. 1A is a block diagram illustrating an example of a video-mode display system. In general, video mode refers to transactions taking the form of a real-time pixel stream. In some embodiments, a real-time pixel stream may include a full frame of content for each refresh cycle of a display panel receiving the pixel stream. In the example of FIG. 1A, a host device 100 includes a timing control unit 102, a frame buffer 104, and a bus interface 106. Furthermore, in the example of FIG. 1A, a video mode display panel 108 includes a bus interface 110, a display driver 112, and a display screen 114.

Frame buffer 104 of host device 100 stores pixel data for display on display panel 108. Pixel data in frame buffer 104 may be updated by applications, a display processor, a graphics processing unit (GPU), a central processing unit (CPU), or other components of host device 100. Timing control unit 102 controls a rate at which bus interface 106 transfers pixel data from frame buffer 104 to bus interface 110. For instance, timing control unit 102 may cause bus interface 106 to transfer pixel data at a rate of 60 frames per second (FPS). Bus interface 110 of display panel 108 receives pixel data from bus interface 106. Display driver 112 of display panel 108 processes the pixel data for display on display screen 114. In the example of FIG. 1A, the pixel data happens to represent a picture of a mountain. In some examples, host device 100 is or includes a Display Serial Interface (DSI) host that operates in the video mode. DSI is a protocol used to transfer data onto a display panel. When a DSI host operates in the video mode, the DSI host refreshes image data continuously and may be used with a “dumb” display panel that does not include its own RAM.

FIG. 1B is a block diagram illustrating an example of a command-mode display system. In the example of FIG. 1B, a host device 150 includes a display engine 151 and a bus interface 152. A command mode display panel 154 includes a bus interface 156, a display controller 158, a frame buffer 160, and a display screen 162. Applications, a display processor, a GPU, CPU, or components of host device 150 may generate updated frame buffer data (i.e., pixel data) and display engine 151 may process the pixel data into a pixel stream for transmission on bus interface 152 of host device 150. Bus interface 156 of display panel 154 receives the pixel data from bus interface 152. Display controller 158 of display panel 154 receives pixel data from bus interface 156 and stores the pixel data into frame buffer 160 of display panel 154. Display panel 154 refreshes the content of display screen 162 based on pixel data stored in frame buffer 160. In the example of FIG. 1B, the content happens to be a picture of a mountain.

In some examples, host device 150 is or includes a DSI host that operates in the command mode. Command mode refers to transactions taking the form of sending commands and data to a peripheral DSI driver implemented by display controller 158 of command mode display panel 154. The DSI driver is peripheral because it is not included in the device that generates the commands and data. The command mode may be used for a “smart” display panel with external RAM (e.g., frame buffer 160) which can self-refresh in the case of a static image update. In some embodiments, a static image update may not change content displayed on display screen 162. In command mode, display engine 151 of host device 150 can go into a low power state to save power when it is not necessary to update the content display by command mode display panel 154.

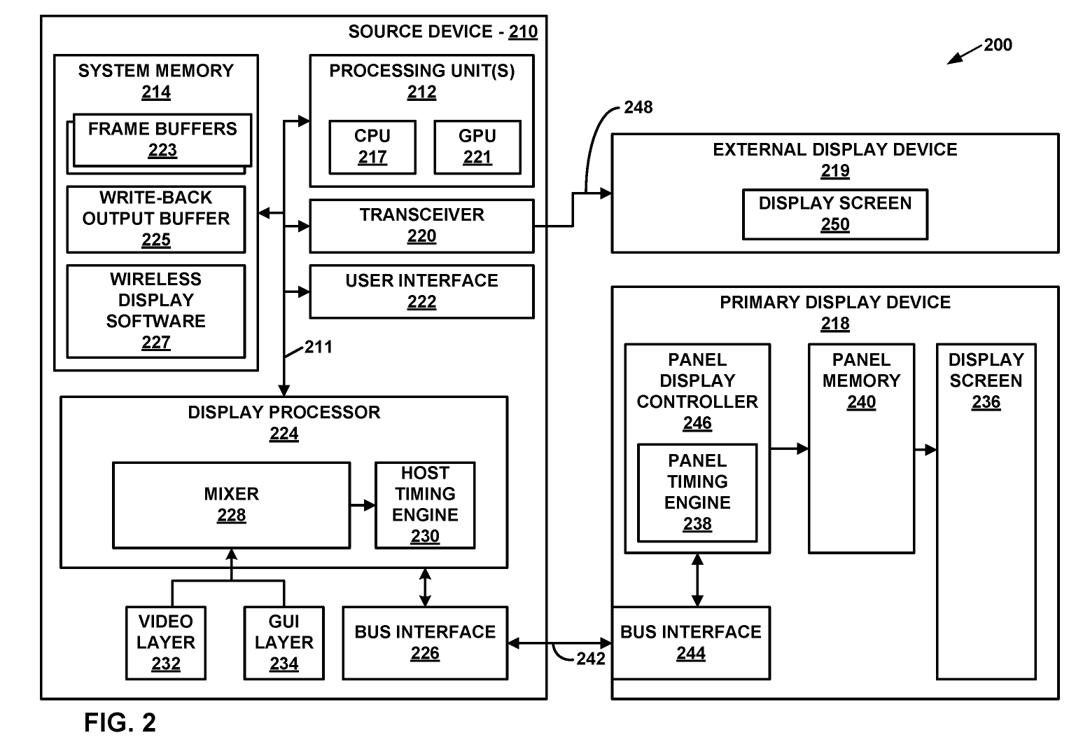

FIG. 2 is a block diagram illustrating an example system 200 that includes a source device 210, a primary display device 218, and an external display device 219, that may be configured to implement one or more aspects of this disclosure. Source device 210 is an example of a “host device.” Source device 210 may be a video device, a media player, a set-top box, a wireless handset such as a mobile telephone or a so-called smartphone, a personal digital assistant (PDA), a desktop computer, a laptop computer, a gaming console, a video conferencing unit, a tablet computing device, or another type of computing device.

In the example of FIG. 2, source device 210 includes processing unit(s) 212 (e.g., a CPU and/or GPU), a system memory 214, a transceiver 220, a user interface 222, and an interconnection 211. Interconnection 211 may enable communication between system memory 211, transceiver 220, user interface 222, display processor 224. Interconnection 211 may include one or more buses. Source device 210 may communicate with primary display device 218 and external display device 219.

In some examples, primary display device 218 is an included component of source device 210. In other examples, primary display device 218 is external to source device 210 and source device 210 communicates with primary display device 218. In some examples where primary display device 218 is external to source device 210, primary display device 218 includes an external monitor, television, or projector. In other examples, primary display device 218 is internal to an integrated device with a built-in display such as a smartphone, tablet computer, or laptop computer. External display device 219 may be various types of devices. For instance, external display device 219 may be a telephone handset, a television, a personal computer, a tablet computer, a video projector, a wearable computing device, or another type of device that includes a display screen. Furthermore, in some examples, external display device 219 does not itself include a display screen, but rather receives and processes data for display on a device that includes a display screen. For instance, in such examples, external display device 219 may be a video stick, dongle, set-top box, media streaming device, or other type of device.

Primary display device 218 can be configured to operate as a command mode display panel. In the example of FIG. 2, primary display device 218 includes a display screen 236, a panel memory 240, a bus interface 244, and a panel display controller 246. Display screen 236 may display image content generated by source device 210 (with e.g., processing unit(s) 212), e.g., such as rendered graphics data, video data, interface and graphical user interface (GUI) overlay data. Display screen 236 may be a Liquid Crystal Display (LCD), an organic light emitting diode display (OLED), a plasma display, electronic ink, or another type of display device.

It should be understood that other examples of source device 210, primary display device 218, and external display device 219 may include more, fewer, or an alternative arrangement of components than those shown. For example, source device 210 may include a speaker and/or a microphone, neither of which are shown in FIG. 2, to effectuate telephonic communications in examples where source device 210 is a mobile wireless telephone. In examples where source device 210 is a media player, source device 210 may include a speaker. Source device 210 may also include a video camera. In some examples, certain units such as transceiver 220 or display processor 224 are part of the same integrated circuit (IC) as processing unit(s) 212, may be external to an IC or ICs that include processing unit(s) 212, or may be formed in an IC that is external to an IC that includes processing unit(s) 212.

Processing unit(s) 212 may include a CPU 217 that includes a general-purpose or a special-purpose processor that controls operation of source device 210. For example, CPU 217 may include one or more processors, such as one or more microprocessors, application-specific integrated circuits (ASICs), field-programmable gate arrays (FPGAs), digital signal processors (DSPs), or other equivalent integrated or discrete logic circuitry.

Processing unit(s) 212 may also include a Graphics Processing Unit (GPU) 221. CPU 217 may issue one or more graphics rendering commands to GPU 221 to cause GPU 221 to render graphics data. GPU 221 may include a programmable pipeline of processing components having a highly parallel structure that provides efficient processing of complex graphics-related operations. GPU 221 may include one or more processors, such as one or more microprocessors, ASICs, FPGAs, DSPs, or other integrated or discrete logic circuitry. GPU 221 may also include one or more processor cores, such that GPU 221 may be referred to as a multi-core processor. In some instances, GPU 221 is integrated into a motherboard (not shown) of source device 210. In other instances, GPU 221 may be present on a graphics card (not shown) that is installed in a port in the motherboard of source device 210 or may be otherwise incorporated within a peripheral device configured to interoperate with source device 210.

Processing unit(s) 212 may store data to and read data from system memory 214. System memory 214 may store instructions that, when executed by processing unit(s) 212, cause source device 210 to perform various functions. For example, system memory 214 may store instructions that, when executed by processing unit(s) 212, cause source device 210 to provide various applications, such as providing an operating system that controls the operation of components of source device 210. For instance, in the example of FIG. 2, system memory 214 stores instructions for wireless display software 227 that facilitates transmission of pixel data to external display device 219 during a wireless display session.

System memory 214 may also be used by software or applications executed by source device 210 to store information during program execution. System memory 214 may include a computer-readable storage medium or a computer-readable storage device. In some examples, system memory 214 includes one or more of a short-term memory or a long-term memory. System memory 214 may include, for example, RAM, dynamic RAM (DRAM), static RAM (SRAM), cache memory, magnetic hard discs, optical discs, flash memories, or forms of electrically programmable memories (EPROM) or electrically erasable and programmable memories (EEPROM). Similarly, panel memory 240 may include, for example, RAM, DRAM, static SRAM, cache memory, magnetic hard discs, optical discs, flash memories, or forms of EPROM or EEPROM. Panel memory 240 may be referred to as Graphical Random Access Memory (G-RAM).

System memory 214 may include frame buffers 223 that store pixel data for processing by processing unit(s) 212 and/or display processor 224. Each pixel may be associated with a unique screen pixel location. In some examples, frame buffers 223 store color components and a destination alpha value for each destination pixel. For example, a frame buffer may store Red, Green, Blue, Alpha (RGBA) components for each pixel where the “RGB” components correspond to color values and the “A” component corresponds to a destination alpha value (e.g., a transparency value that may be used in compositing, which may also be referred to as opacity). In some examples, frame buffers 223 are in a separate unit from system memory 214. In the example of FIG. 2, system memory 214 may also include a write-back output buffer 225 that is used for storing pixel data for output to external display device 219 during a wireless display session.

Transceiver 220 may include circuitry to allow wireless or wired communication between source device 210 and another device or a network. Transceiver 220 may include antennas, modulators, demodulators, amplifiers, and other such circuitry for wired or wireless communication.

User interface 222 may allow a user to provide input to source device 210. Examples of user interface 222 include, but are not limited to, a trackball, a mouse, a keyboard, and other types of input devices. User interface 222 may also be a touch screen and may be incorporated as a part of primary display device 218.

In the example of FIG. 2, source device 210 further includes a bus interface 226. Furthermore, in the example of FIG. 2, display processor 224 includes a mixer 228 and a host timing engine 230. Display processor 224 is a hardware unit that includes processing circuitry that processes pixel data for display.

Display processor 224 may receive pixel data from frame buffers 223. As described in greater detail elsewhere in this disclosure, display software running on processing unit(s) 212 may provide layer objects (i.e., layers) to applications and/or an operating system of source device 210. Each of the layers may include one or more of frame buffers 223. An application or operating system may store pixel data into the frame buffers of a layer provided to the application or operating system. The display software may identify layers that include pixel data to be displayed during a refresh cycle. The display software may then use the pixel data of the identified layers to generate a composited pixel data set in a stream of pixel data sent to primary display device 218 or external display device 219. Compositing layers may refer to compositing pixel data in frame buffers of the layers.

For instance, in the example of FIG. 2, display processor 224 may identify a video layer 232 and a GUI layer 234. Although shown in the example of FIG. 2 as being separate from system memory 214 for the sake of clarity, video layer 232 and GUI layer 234 may each include different frame buffers in the set of frame buffers 223. Video layer 232 includes video and graphics content. The video content may have been produced locally (via e.g., a camera on source device 210, by an application running on source device 210, by a video decoder of source device 210, etc.), or may be produced on an external device and retrieved or downloaded by, e.g., transceiver 220 of source device 210. Processing unit(s) 212 may decode video in video layer 232 for playback. GUI layer 234 includes other graphical elements that provide a user interface. These interface elements include for example a camera interface software (e.g., a “shutter” button, camera switch buttons, settings, and menus), media player interface (e.g., play/pause buttons, menus, and settings), operating system/program interfaces including an interface to scroll through installed applications, settings, menus, and internet/web browser interfaces.

Mixer 228 may be designed to perform 2D operations on pixel data to be displayed (e.g., blending compositing, overlay, rotating, upscaling, downscaling, and stretching). Furthermore, mixer 228 may be configured to update panel memory 240 at a variable or constant rate so that display screen 236 may be refreshed from panel memory 240. For example, mixer 228 may blend, composite, or overlay different GUI elements from GUI layer 234 over video/graphical elements from video layer 232 into a display view. The display view is the combination of video/graphical and GUI elements (overlays) that a user is able to view on display screen 236 of primary display device 218 and/or display screen 250, and interact with via user interface 222.

Bus interface 226 may connect to primary display device 218 over a link 242. More specifically, bus interface 226 may communicate with bus interface 244 of primary display device 218 over link 242. For instance, display processor 224 may send instructions to primary display device 218 over link 242 using bus interface 226. Link 242 may include a bus connection such as a Display Serial Interface (DSI) point-to-point serial bus connection or other physical wired (e.g., a High-Definition Multimedia Interface (HDMI), a digital video interface (DVI) connection, a DisplayPort (or variants such as embedded DisplayPort (eDP) connection)), or wireless links such as wireless DisplayPort (wDP).

Panel timing engine 238 is configured to generate a desired timing based on several factors such as a display refresh rate, a display resolution, and panel (e.g., horizontal and vertical, front and back) porches. In this context, a porch is a time interval between blanking of a display screen and a beginning of redrawing content on the display screen. Different panels may have different porches. For each refresh cycle of primary display panel, panel timing engine 238 may send a signal (e.g., a vertical synchronization (VSYNC) signal) to host timing engine 230 via link 242. In response to the signal, host timing engine 230 may receive pixel data generated by mixer 228 and may determine whether to send the pixel data or portions of the pixel data to primary display device 218. Pixel data may be sent either at a constant rate (e.g., constant frequency) or at a variable rate. Host timing engine 230 and panel timing engine 238 may include a handshake to coordinate synchronization of the data to be sent.

Panel display controller 246 may be configured to receive pixel data from display processor 224 and store the pixel data in panel memory 240 for later display on display screen 236. Panel timing engine 238 of panel display controller 246 may be configured to determine a refresh rate for all or part of the display screen 236 and send the pixel data at the appropriate interval to refresh display screen 236. Panel timing engine 238 may determine the timing interval based on instructions received from display processor 224 or may do so independently based on the source and type of pixel data.

Panel memory 240 may include a bitmap or a portion of a bitmap containing all or a portion of a frame of data to be displayed on display screen 236. Panel memory 240 may include a frame buffer which converts an in-memory bitmap (or a portion of a bitmap) into a video signal for use by display screen 236. Display screen 236 may receive pixel data from panel display controller 246 and/or panel memory 240 and may cause the pixels of display screen 236 to illuminate to display the image at a refresh interval set by panel timing engine 238. This disclosure may refer to a stream of pixel data that source device 210 sends to primary display device 218 as a primary stream of pixel data.

In addition to sending the primary stream of pixel data to primary display device 218, source device 210 may send an external stream of pixel data to external display device 219 via a channel 248 when source device 210 is engaged in a wireless display session with external display device 219. External display device 219 uses pixel data in the external stream to update content displayed on display screen 250. Typically, the external stream of pixel data contains pixel data such that the content displayed on display screen 250 of external display device 219 matches the content displayed on display screen 236. However, at least because primary display device 218 may operate in the command mode, it is possible that the primary stream and the external stream do not contain the same sets of pixel data.

Channel 248 generally represents any suitable communication medium, or collection of different communication media, for transmitting media data, control data and feedback between source device 210 and external display device 219. Channel 248 may include a wireless channel, such as a relatively short-range communication channel, and may implement a physical channel structure defined by WI-FI™, BLUETOOTH™, or other wireless communication protocols. In some examples, channel 248 may be implemented using defined 2.4 gigahertz (GHz), 3.6 GHz, 5 GHz, 60 GHz or Ultrawideband (UWB) frequency band structures. However, channel 248 is not necessarily limited in this respect, and may include a wireless communication medium, such as a radio frequency (RF) spectrum or one or more physical transmission lines, or a combination of wireless and wired media. In some examples, channel 248 may include a relatively long-range wireless communication channel, such as a cellular data communication standard. In other examples, channel 248 may form part of a packet-based network, such as a wired or wireless local area network, a wide-area network, or a global network such as the Internet. Additionally, channel 248 may be used by source device 210 and external display device 219 to create a peer-to-peer link.

Source device 210 and external display device 219 may establish a communication session according to a capability negotiation using, for example, Real-Time Streaming Protocol (RTSP) control messages. In one example, a request to establish a communication session may be sent by source device 210 to external display device 219. Once the communication session is established, source device 210 may transmit media data, e.g., audio video (AV) data, to external display device 219. Source device 210 may transmit media data (e.g., pixel data) to external display device 219, for example, using the Real-time Transport protocol (RTP). External display device 219 may render the received media data on a display screen 250.

Source device 210 and external display device 219 may communicate over channel 248 using a communication protocol such as a standard from the IEEE 802.11 family of standards. In one example, channel 248 may be a network communication channel. In this example, a communication service provider may centrally operate and administer the network using a base station as a network hub. Source device 210 and external display device 219 may, for example, communicate according to the WI-FI Direct or WI-FI Display (WFD) standards, such that source device 210 and external display device 219 may communicate directly with one another without the use of an intermediary such as a wireless access point or a so-called hotspot. Relatively short distance in this context may refer to, for example, less than approximately seventy meters, although in a noisy or obstructed environment, the distance between devices may be even shorter, such as less than approximately thirty-five meters, or less than approximately twenty meters.

The techniques of this disclosure may be described with respect to WFD, but it is contemplated that aspects of these techniques may also be compatible with other communication protocols. By way of example and not limitation, the wireless communication between source device 210 and external display device 219 may utilize orthogonal frequency division multiplexing (OFDM) techniques. A wide variety of other wireless communication techniques may also be used, including but not limited to time division multiple access (TDMA), frequency division multiple access (FDMA), code division multiple access (CDMA), or any combination of OFDM, FDMA, TDMA and/or CDMA. Still other wireless communication techniques include standards from the Bluetooth™ family of standards.

In general, techniques of this disclosure can save power during wireless display session for devices, such as source device 210, that use command mode display panels, such as primary display device 218. In some embodiments, to save power during a wireless display session, source device 210 may operate in an external-only update mode when there is ongoing full-screen video playback. When source device 210 is in the external-only update mode, source device 210 avoids compositing layers for display on primary display device 218. If such composition is avoided, primary display device 218 can continue to refresh displayed content from panel memory 240 and display processor 224 may switch to a lower-power mode. When in the lower-power mode, display processor 224 does not compose layers for display on primary display device 218, and therefore uses less electrical power. However, display processor 224 may continue to generate the external data stream. Thus, when in the lower-power mode, display processor 224 may discontinue generating the primary stream, while continuing to generate the external stream. For instance, avoiding composition of layers for display on primary display device 218 may reduce display core clock frequency, display Advanced Extensible Interface (AXI) bandwidth requirements, DSI interface pixel clock frequency, and GPU rendering for primary layers. The display core clock is used for processing pixels for composition by the display processor. The display core clock may depend on layer width, height, bits per pixel and FPS. AXI is a bus protocol used to fetch layer data from a memory, such as system memory 214. For instance, interconnection 211 may be or include a bus that uses AXI. AXI bandwidth requirements are demands placed on the bandwidth of a bus to transfer data from the memory according to the AXI bus protocol. The DSI pixel clock is a clock with which a display interface (such as bus interface 226) processes the pixels transferred by a display processor, such as display processor 224, that includes a timing engine, such as host timing engine 230. Because primary display device 218 continues to refresh display content from panel memory 240, but display processor 224 is no longer compositing layers, the content displayed on display screen 236 may remain static, but video playback may continue on display screen 250 of external display device 219.

Thus, in one example in accordance with a technique of this disclosure, source device 210 may initiate a wireless display session with external display device 219. During the wireless display session, source device 210 may operate in a dual update mode. Based on source device 210 operating in the dual update mode during the wireless display session, source device 210 may generate a primary stream of pixel data for display on primary display device 218. Additionally, when source device 210 is operating the dual update mode, source device 210 may generate an external stream of pixel data for display on external display device 219. Source device 210 may change from the dual update mode to an external-only update mode during the wireless display session. For instance, source device 210 may change from the dual update mode to the external-only update mode responsive to source device 210 determining that full-screen playback of video content is occurring or is about to occur on primary display device 218 and external display device 219 during the wireless display session.

Based on source device 210 operating in the external-only update mode during the wireless display session, source device 210 may discontinue generation of the primary stream. As a result, updates to the content displayed by primary display device 218 may stop. For instance, full-screen playback of video content may stop on primary display device 218. Because source device 210 has discontinued generation of the primary stream, primary display device 218 may continue to refresh the content displayed on display screen 236 based on pixel data stored in panel memory 240, which is no longer being updated. Thus, when source device 210 discontinues generation of the primary stream, content on primary display device 218 appears to stop being updated. For instance, playback of video content on primary display device 218 may stop and primary display device 218 may continue to display a single static frame. Furthermore, when source device 210 is operating in the external-only update mode, source device 210 concurrently continues to generate the external stream. Thus, updates to the content displayed by external display device 219 may continue. For instance, full-screen playback of the video content may continue on external display device 219 while the full-screen playback of the video content is stopped on primary display device 218.

In some examples of this disclosure, source device 210 may toggle layer composition for primary display device 218 on and off in response to receiving an indication of a user input, such as a toggle gesture. In other words, source device 210 may switch back and forth between the dual update mode and the external-only update mode in response to detecting a toggle gesture and/or any automatic or user-based selection of the mode. The toggle gesture may include a double-tap gesture on a touch-sensitive display screen, a swiping gesture, a long-press gesture, a single-tap gesture, pushing a physical or virtual button, squeezing edges of source device, a pinching or finger separation gesture, a multi-finger tap or swipe gesture, or another type of user input. In some instances, display screen 236 of primary display device 218 is a touch-sensitive display screen. Thus, a user may cause video playback to resume on display screen 236 by providing user input, such as a double-tap gesture, on display screen 236.

Moreover, if source device 210 is operating in the external-only update mode, a user may cause video playback to stop or start on primary display device 218 while video playback continues on display screen 250 by providing user input, such as a second double-tap gesture on display screen 236. In other words, if primary display device 218 receives touch input (e.g., a double-tap gesture) then, based on the current composition strategy (e.g., video playback on primary display device 218 or no video playback on primary display device 218), source device 210 changes that current composition strategy.

In this way, in response to detecting a first toggle gesture while source device 210 is operating in the external-only update mode during a wireless display session, source device 210 may change from the external-only update mode to the dual update mode. Based on source device 210 changing from the external-only update mode to the dual update mode, source device 210 may resume generation of the primary stream. Moreover, in response to detecting a second toggle gesture while source device 210 is operating in the dual update mode, source device 210 may change from the dual update mode to the external-only update mode.

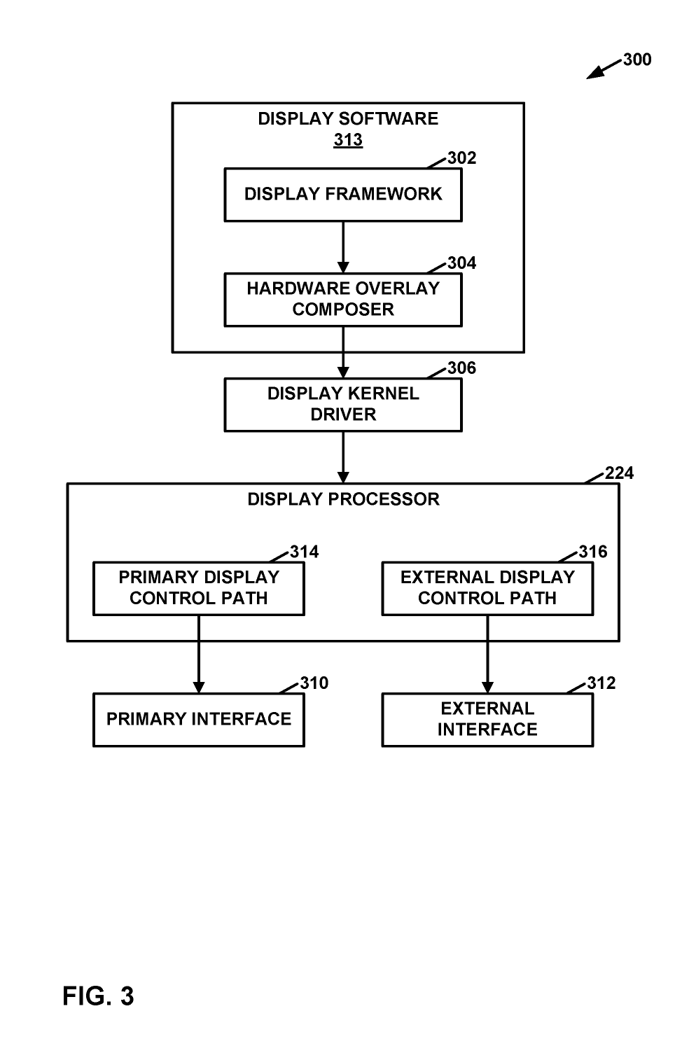

FIG. 3 is a block diagram illustrating an example display stack 300 in source device 210, in accordance with one or more aspects of this disclosure. Display stack 300 represents an example of hardware and software processes that may be used to generate layers for display on the primary display and/or external display. In the example of FIG. 3, display stack 300 includes a display framework 302, a hardware overlay composer 304, a display kernel driver 306, display processor 224, a primary interface 310, and an external interface 312. Display framework 302 and hardware overlay composer 304 may be referred to herein as display software 313. In some examples, display framework 302 and hardware overlay composer 304 run in user space, as opposed to kernel space. Display kernel driver 306 may operate in kernel space. CPU 217 (FIG. 2) may execute software instructions that cause source device 210 to perform the functions of display framework 302, hardware overlay composer 304, and display kernel driver 306. As noted above, display processor 224 is a hardware unit that includes processing circuitry that processes pixel data for display. Hence, display processor 224 may be referred to as display hardware. In the example of FIG. 3, display processor 224 includes a primary display control path 314 and an external display control path 316. Primary display control path 314 and external display control path 316 may, in some embodiments, include separate circuitry for controlling generation of the primary stream and external stream, respectively.

Furthermore, in the example of FIG. 3, display framework 302 may receive a request from an application manager of source device 210 to generate a layer for an application. The application manager may be part of an operating system of source device 210. In some instances, the application manager can request that display framework 302 generate the layer when an application comes to the foreground. In some instances, the application may be a part of the operating system responsible for maintaining a status bar, a navigation bar, or other on-screen aspects of the operating system. An application may come to the foreground when the application is newly launched (e.g., in response to user input, as part of device startup, etc.) or when the application returns from the background. The layer itself may be an object-oriented programming object.

In response to a request to generate a layer for an application, display framework 302 may allocate locations in system memory 214 for one or more frame buffers (e.g., one or more of frame buffers 223 of FIG. 2). From an application's perspective, the frame buffers may be objects within a layer object. Display framework 302 may pass a reference to the layer through the application manager to the application, thereby providing to the application references to the layer and to the frame buffers of the layer. In this way, the layer and its frame buffers are associated with the application.

An application may be associated with multiple layers. For example, a camera application may be associated with a first layer and a second layer. The first layer may correspond to a live view from a camera. The second layer may correspond to user interface controls for the camera (e.g., a shutter button, a camera selection button, etc.).

As noted above, a layer associated with an application may have one or more frame buffers. For example, the layer associated with an application may have three buffers for triple buffering. An application may populate pixel data into the frame buffers of a layer associated with an application directly, may use GPU 221 to store pixel data into the frame buffers, or may use functions of a graphics Application Programming Interface (API), such as an OpenGL API, that store pixel data into the frame buffers. The graphics API may be part of an operating system of source device 210 or may be separate from the operating system of source device 210.

In addition to generating layers, display framework 302 may receive a signal (e.g., from host timing engine 230 or panel timing engine 238) when it is time to refresh the content of primary display device 218. This signal may be referred to as a VSYNC signal. In some examples, the VSYNC signal is generated sixty times per second, resulting in a frame rate of 60 fps. In response to the VSYNC signal, display framework 302 identifies which of the layers have frame buffers 223 that store pixel data to be shown in the current refresh cycle. When an application uses double- or triple-buffering, an application may be storing pixel data into one of the frame buffers of a layer associated with the application while pixel data in another one of the frame buffers of the layer associated with the application is ready to be shown in the current refresh cycle. The frame buffers of the identified layers may include frame buffers in layers associated with one or more applications, frame buffers in multiple layers associated with the same application, frame buffers in layers associated with the operating system, etc. In some examples, frame buffers in layers associated with the operating system may contain pixel data representing a status bar (e.g., containing a pixel data indicating a time, a wireless signal strength, a wireless service provider, etc.), a navigation bar (e.g., containing pixel data representing a virtual “home” button, a navigate back button, an application switcher button, etc.), or other features.

Furthermore, display framework 302 may ask hardware overlay composer 304 how composition should be performed for the identified frame buffers. For instance, display framework 302 may provide to hardware overlay composer 304 a list of identified layers (or, in some examples, a list of frame buffers in the identified layers). Hardware overlay composer 304 determines the most efficient way to composite the identified frame buffers with the available hardware of source device 210. Hardware overlay composer 304 may be a hardware abstraction layer (HAL). Hence, the implementation of hardware overlay composer 304 may be device-specific. In some examples, hardware overlay composer 304 may instruct display framework 302 to composite some or all layers in the list of layers, and may instruct display processor 224 to handle composition of any remaining layers in a scratch buffer. A scratch buffer is a buffer in memory (e.g., system memory 214) that may be used to store pixel data, but is not necessarily a frame buffer that contains a full frame of pixel data that is ready for display. Display framework 302 may use a graphics rendering API (e.g., OPENGL for Embedded Systems (ES) (TM) API) to composite the layers (e.g., using GPU 221). Subsequently, display processor 224 may composite, in a scratch buffer, the pixel data of any layers composited by display framework 302 with pixel data of any layers composited by display framework 302.

Thus, in one example, source device 210 may store (e.g., based on instructions of an application running on source device 210), for display during a first refresh cycle, uncomposited pixel data into a frame buffer of a first layer and into a frame buffer of a second layer. For instance, source device 210 may include a dedicated hardware video decoder that stores pixel data in the frame buffer. The pixel data may be uncomposited in the sense that display processor 224 and/or GPU 221 has not composited the pixel data with pixel data from any other layer. The frame buffer of the first layer and the frame buffer of the second layer may be in system memory 214 of source device 210. Furthermore, in this example, display framework 302 may identify, for display during the first refresh cycle, a first set of layers and a second set of layers. In this example, the first set of layers includes at least the first layer and the second set of layers includes at least the second layer. Display framework 302 may identify a set of layers for display during a refresh cycle based on a variable that indicates that the layer contains pixel data for display. Display framework 302 may set the value of the variable to indicate that a layer contains pixel data for display based on which application is in the foreground. In some examples, display framework 302 arranges the layers in z-order (e.g., from top to bottom) to determine which layers appear in front of other layers. Additionally, hardware overlay composer 304 may determine a first work allocation plan that indicates which, if any, layers in the first set of layers to composite using display processor 224 and which, if any, layers in the first set of layers to composite using GPU 221. In this example, hardware overlay composer 304 may also determine a second work allocation plan that indicates which, if any, layers in the second set of layers to composite using display processor 224 and which, if any, layers in the second set of layers to composite using GPU 221. It should be noted that in other examples, display processor 224 and GPU 221 are the same processor.

Display kernel driver 306 is a driver that operates in a kernel space, as opposed to user space. In some examples, display kernel driver 306 is part of an operating system of source device 210. Display software 313 (e.g., display framework 302 and/or hardware overlay composer 304) may use functions provided by display kernel driver 306 to interact with display processor 224. For example, display software 313 may use functions provided by display kernel driver 306 to instruct display processor 224 to composite particular layers. Additionally, display software 313 may use functions provided by display kernel driver 306 to commit pixel data for display on primary display device 218 and/or external display device 219. When pixel data is committed for display on primary display device 218, display processor 224 may cause primary interface 310 to send the pixel data to primary interface 310. Similarly, when pixel data is committed for display on external display device 219, display processor 224 may cause external interface 312 to send the pixel data to external display device 219.

Typically, during a wireless display session, display framework 302 identifies and provides a first set of layers to hardware overlay composer 304 for composition for display on primary display device 218 and identifies and provides a second set of layers to hardware overlay composer 304 for composition for display on external display device 219. The layers for composition for display on primary display device 218 may be referred to herein as primary layers and the layers for composition for display on external display device 219 may be referred to herein as external layers. Display framework 302 may provide both the primary layers and external layers to hardware overlay composer 304 in response to the same VSYNC signal. Hardware overlay composer 304 may treat the first and second sets of layers separately. Thus, for each refresh cycle, hardware overlay composer 304 may determine how to composite the primary layers and may separately determine how to composite the external layers. Furthermore, hardware overlay composer 304 may instruct display framework 302 and/or display processor 224 to composite layers in the set of primary layers. Separately, hardware overlay composer 304 may instruct display framework 302 and/or display processor 224 to composite layers in the set of external layers.

In the example of FIG. 3, while source device 210 is engaged in a wireless display session with external display device 219 and source device 210 is in the dual update mode, primary display control path 314 of display processor 224 may control display processor 224 such that display processor 224 generates a primary stream and external display control path 316 of display processor 224 may control display processor 224 such that display processor 224 generates an external stream. The set of pixel data in the primary stream for a refresh cycle may differ from the set of pixel data in the external stream for the same refresh cycle. For example, because primary display device 218 operates in the command mode, it might only send updated pixel data, not full frames of pixel data, to primary display device 218. However, in this example, it might send full frames of pixel data to external display device 219 for each refresh cycle because external display device 219 operates in video mode.

While source device 210 is operating in the external-only update mode, display software 313 may disable primary display control path 314 such that display processor 224 stops generating the primary stream. When display processor 224 stops generating the primary stream, display processor 224 stops sending pixel data to primary display device 218. Because primary display device 218 is operating in the command mode, primary display device 218 may continue to refresh the content display on display screen 236 from pixel data stored in panel memory 240. Thus, when the primary stream is stopped, display screen 236 may continue to display the same content. Furthermore, while source device 210 is operating in the external-only update mode, external display control path 316 may control display processor 224 such that display processor 224 continues to generate the external stream.

For example, source device 210 may store (e.g., based on instructions of an application running on source device 210), for display during a first refresh cycle, uncomposited pixel data into a frame buffer of a first layer and into a frame buffer of a second layer. In the example, the frame buffer of the first layer and the frame buffer of the second layer may be system memory 214 of source device 210. Furthermore, in this example, display framework 302 may identify, for display during the first refresh cycle, a first set of layers and a second set of layers. The first set of layers includes at least the first layer and the second set of layers includes at least the second layer. Based on source device 210 operating in the dual update mode, primary display control path 314 may control display processor 224 such that display processor 224 generates a first set of composited pixel data in the primary stream based on the first set of layers. In this example, the first set of composited pixel data is for display in the first refresh cycle. In one example, display processor 224 composites each of the one or more layers in the first set of layers to generate the first set of composited pixel data. In another example, GPU 221 generates one or more sets of pixel data by compositing one or more layers of the first set of layers. In this example, display processor 224 generates the first set of composited pixel data by compositing one or more layers of the first set of layers with the one or more sets of pixel data generated by GPU 221. In another example, display processor 224 uses a layer composited by GPU 221 from the first set of layers as the first set of composited pixel data. Primary interface 310 (e.g., bus interface 226 of FIG. 2) may send to primary display device 218 the first set of composited pixel data.

Furthermore, in this example, external display control path 316 may control display processor 224 such that display processor 224 generates a second set of composited pixel data in the external stream based on the second set of layers. In this example, the second set of composited pixel data is also for display in the first refresh cycle mentioned above. Display processor 224 may generate the second set of composited pixel data based on the second set of layers in any of the ways described above for generating the first set of composited pixel data based on the first set of layers. Controlling display processor 224, by either primary display control path 314 or external display control path 316, may include generating signals, setting control data, or performing other actions that cause display processor 224 to perform certain actions. In this example, external interface 312 (e.g., transceiver 220) may send to external display device 219 the second set of composited pixel data. In some examples, display processor 224 writes the second set of composited pixel data to write-back output buffer 225 (FIG. 2) in system memory 214. Wireless display software 227 (FIG. 2) running on processing unit(s) 212 may read pixel data from write-back output buffer 225 and may process the pixel data for transmission via transceiver 220 to external display device 219. For instance, wireless display software 227 may encapsulate the pixel data into packets, generate redundancy check data, etc. to improve transmission of the pixel data to external display device 219.

Additionally, source device 210 may store (e.g., based on the instructions of an application), for display during a second refresh cycle of the primary display device (which may be one or more refresh cycles before or after the first refresh cycle), second pixel data into the frame buffer of the first layer and the frame buffer of the second layer. In this example, display framework 302 may identify, for display during the second refresh cycle, a third set of layers and a fourth set of layers. The third set of layers includes at least the first layer and the fourth set of layers includes at least the second layer. The third set of layers may be for display on primary display device 218 and the fourth set of layers may be for display on external display device 219. Based on source device 210 operating in the external-only update mode, display software 313 may disable primary display control path 314 such that source device 210 generates in the primary stream no pixel data for display in the second refresh cycle. Consequently, primary display device 218 may continue to display the content that primary display device 218 displayed in the first refresh cycle. In other example applications, rather than continuing to display the content that primary display device 218 displayed in the first refresh cycle, display framework 302 may be configured to place primary display device 218 into an idle mode. During such an idle mode, display framework 302 may be configured to cause primary display device 218 to display an idle screen (e.g., some predetermined image or set of images) or cause primary display device 218 to power off and display nothing.

However, based on source device 210 operating in the external-only update mode, external display control path 316 may control display processor 224 such that display processor 224 generates a third set of composited pixel data based on the fourth set of layers. In this example, the third set of composited pixel data is for display in the second refresh cycle. Display processor 224 may generate the third set of composited pixel data based on the fourth set of layers in any of the ways described above for generating the first set of composited pixel data based on the first set of layers. In this example, external interface 312 may send to external display device 219 the third set of composited pixel data. In some examples, based on source device 210 operating in the external-only update mode, display framework 302 does not identify the third set of layers because source device 210 ultimately does not send pixel data composited from the third set of layers in any pixel stream.

In accordance with a technique of this disclosure, display software 313 may determine whether source device 210 is engaged in a wireless display session with external display device 219. In some examples, display software 313 may determine whether a wireless display session has been created. In some examples, a wireless display session may also be referred to as a “virtual” display session. Additionally, if source device 210 is engaged in a wireless display session with external display device 219, display software 313 (i.e., display framework 302 and/or hardware overlay composer 304) may determine whether a mode change event has occurred, such as when full-screen playback of video content is ongoing or starting during the wireless display session. Display software 313 may determine whether full-screen video playback is ongoing or starting based on incoming information for a layer, such as source start x-coordinate, source start y-coordinate, source width, and source height. Source start x-coordinate and source start y-coordinate for a layer indicate pixel coordinates of a corner (e.g., a top-left corner) of the layer. The source width and source height for the layer indicate the width and height of the layer (e.g., in pixels). Thus, if the source start x-coordinate and source start y-coordinate for the layer correspond to a corner of a display screen, the width of the layer is the same as the width of the display screen, and the height of the layer is the same as the height of the display screen, display software 313 may determine that the layer is in full-screen mode.

In one example of determining whether full-screen playback of video content is occurring or starting, display framework 302 provides a set of layers to hardware overlay composer 304 for both primary display device 218 and external display device 219. Hardware overlay composer 304 may then loop through the layers. For each layer, hardware overlay composer 304 checks the layer's destination width and height. If the layer's width and height match a width and height of frame buffer 223, hardware overlay composer 304 determines that the layer is a full-screen layer. If the layer is a full-screen layer, hardware overlay composer 304 checks a layer format field of the layer to determine whether the layer format of the layer corresponds to video. The layer format field of the layer indicates a format of the pixel data of the layer. For instance, if the layer format field of the layer indicates that the pixel data of the layer is in a YUV format (e.g., as opposed to a Red-Green-Blue-Alpha format), hardware overlay composer 304 may determine that the layer is a video layer. In other examples, hardware overlay composer 304 may first check the layer format field and then check the width and height of the layer. In other examples, display framework 302 may check the layers in the manner described in this paragraph with respect to hardware overlay composer 304. In this manner, display software 313 may determine whether full-screen playback of video content is occurring or about to occur. Note that, in some examples, the layers analyzed by display software 313 may not yet have been sent to primary display device 218 or external display device 219, so playback of the video content at this point is only about to occur, but has not yet occurred.

As noted above, source device 210 may change composition strategies in response to receiving an indication of user input, such as a toggle gesture on display screen 236 of primary display device 218. In the context of FIG. 3, if source device 210 is operating in the dual update mode and source device 210 detects a toggle gesture (e.g., touch inputs, such as a double-tap gesture) then display software 313 may trigger a change in composition for primary display device 218. In other words, display software 313 may cause source device 210 to start operating in the external-only update mode. For instance, display framework 302 may stop compositing layers for primary display device 218 and may avoid primary display commits (i.e., storing composited pixel data for display on primary display device 218) on display processor 224. Primary display device 218 may refresh from old pixel data stored in panel memory 240. If computing device 210 is operating in the external-only update mode, and source device 210 again detects the toggle gesture, display software 313 may cause source device 210 to switch back to normal composition (i.e., the dual update mode) and again start compositing frames for primary display device 218.

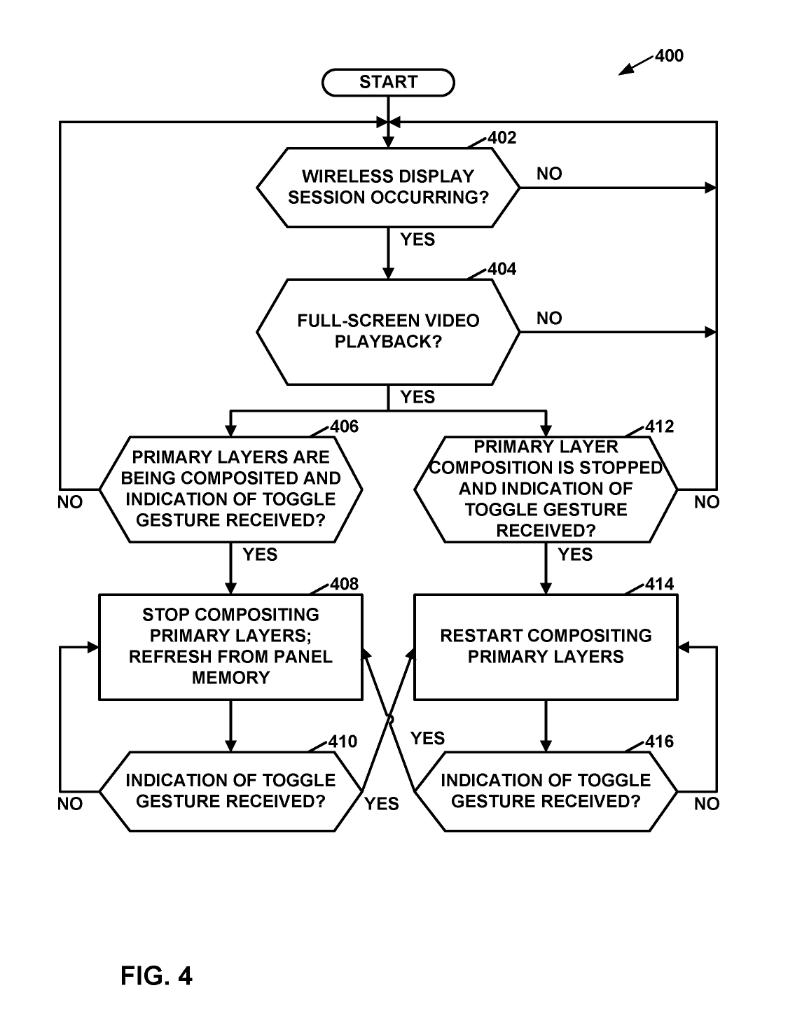

FIG. 4 is a flowchart illustrating an example operation 400 of source device 210, in accordance with one or more aspects of this disclosure. The flowcharts of this disclosure are provided as examples. In other examples in accordance with techniques of this disclosure, similar operations may be performed with more, fewer, or different actions, or actions performed in different orders or in parallel.

In the example of FIG. 4, display software 313 (e.g., display framework 302 or hardware overlay composer 304) may detect whether a wireless display session is occurring (402). For example, display software 313 may store data in system memory 214 indicating whether a wireless display session is occurring. In this example, display software 313 may detect whether a wireless display session is occurring based on values of stored data indicating that a wireless display session is occurring. If a wireless display session is not occurring (“NO” branch of 402), no further actions are taken in operation 400 and display software 313 may subsequently check again whether a wireless display session is occurring (402).

On the other hand, in response to determining that a wireless display session is occurring (“YES” branch of 402), display software 313 may determine whether full-screen video playback is occurring or about to occur (404). Display software 313 may determine whether full-screen video playback is occurring in the manner described elsewhere in this disclosure. If full-screen video playback is not occurring or about to occur (“NO” branch of 404), no further actions are taken in operation 400 and display software 313 may subsequently check again whether a wireless display session is occurring (402).

However, in response to determining that full-screen video playback is occurring or is about to occur (“YES” branch of 404), display software 313 may determine whether display processor 224 is compositing one or more primary layers and source device 210 has received an indication of a toggle gesture (406). For instance, display software 313 may determine whether display processor 224 is generating sets of pixel data in the primary stream and may determine whether a variable indicates that source device 210 detected the toggle gesture. If display processor 224 is compositing the one or more primary layers and source device 210 has not received an indication of a toggle gesture (“NO” branch of 406), no further actions are taken in operation 400 and display software 313 may subsequently check again whether a wireless display session is occurring (402).

In response to determining that display processor 224 is compositing the one or more primary layers and source device 210 has received an indication of a toggle gesture (“YES” branch of 406), display processor 224 stops compositing the one or more primary layers (408). That is, display processor 224 may discontinue the primary stream. As a result, primary display device 218 may continue to refresh the content of display screen 236 from pixel data stored in panel memory 240. As a result, the same content may continue to appear statically on display screen 236. Display processor 224 may continue to generate the external stream. Subsequently, display software 313 may determine whether source device 210 has received an indication of the toggle gesture (410). If source device 210 has not received an indication of the toggle gesture (“NO” branch of 410), display processor 224 does not compose the primary layers and primary display device 218 may continue to refresh the content of display screen 236 from pixel data stored in panel memory 240. However, in response to determining that source device 210 has received an indication of the toggle gesture (“YES” branch of 410), display processor 224 may restart composition of the primary layers (414). In other words, display processor 224 may resume the primary stream.

Furthermore, in the example of FIG. 4, in response to determining that full-screen video playback is occurring or about to occur (“YES” branch of 404), display software 313 may determine whether composition of the one or more primary layers has stopped and whether source device 210 has received an indication of a toggle gesture (412). If display software 313 is not compositing the one or more primary layers and source device 210 has not received an indication of a toggle gesture (“NO” branch of 412), no further actions are taken in operation 400 and display software 313 may subsequently check again whether a wireless display session is occurring (402).

However, in response to determining that composition of the one or more primary layers has stopped and source device 210 has received an indication of the toggle gesture (“YES” branch of 412), display processor 224 may restart composition of the one or more primary layers (414). Thus, primary interface 310 may resume sending updated pixel data to primary display device 218.

Subsequently, display software 313 may determine whether source device 210 has received an indication of the toggle gesture (416). If source device 210 has not received an indication of the toggle gesture (“NO” branch of 416), display processor 224 may restart or continue composition of the primary layers (414). However, in response to determining that source device 210 has received an indication of the toggle gesture (“YES” branch of 416), display processor 224 stops compositing the one or more primary layers and primary display device 218 may refresh the content of display screen 236 from pixel data stored in panel memory 240 (408).

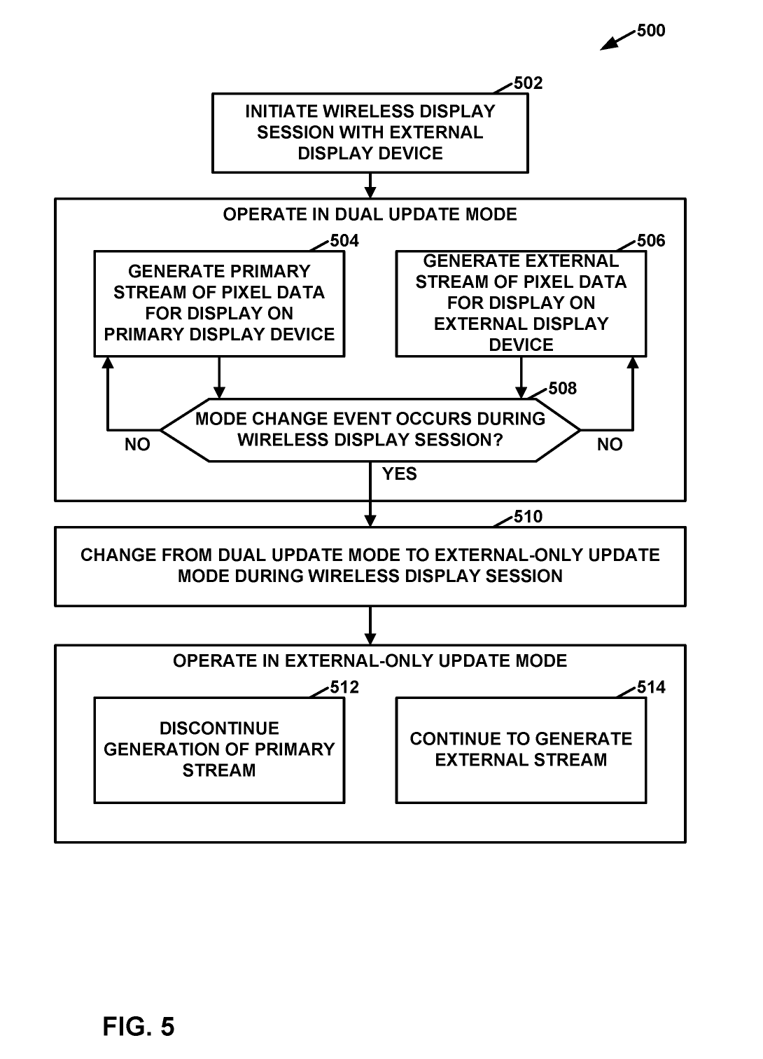

FIG. 5 is a flowchart illustrating an example operation 500 of source device 210, in accordance with a technique of this disclosure. In the example of FIG. 5, source device 210 may initiate a wireless display session with an external display device 219 (502). For instance, source device 210 may exchange data with external display device 219 to establish the wireless display session in accordance with any of various wireless display protocols, such as the MIRACAST™ display protocol.

During the wireless display session, source device 210 may operate in a dual update mode. Based on source device 210 operating in the dual update mode, source device 210 may generate a primary stream of pixel data for display on primary display device 218 (504). Because primary display device 218 operates in the command mode, it may not be necessary for the primary stream to include pixel data for each refresh cycle of primary display device 218, as discussed above. Nevertheless, generation of the primary stream may be considered to continue since source device 210 does generate updated pixel data in the primary stream when changes to the displayed content are to occur. Source device 210 may provide the primary stream to primary display device 218 via a DSI interface. Additionally, source device 210 may generate an external stream of pixel data for display on external display device 219 (506). The external stream of pixel data may include pixel data for each refresh cycle of primary display device 218.

Furthermore, while source device 210 is operating in the dual update mode, source device 210 may determine whether a mode change event has occurred during the wireless display session (508). An example mode change event may be a determination, by source device 210 that full-screen playback of video content is occurring or is about to occur on primary display device 218 and/or external display device 219 during the wireless display session. In other examples, a mode change event may be the launch or opening of a particular application. As described elsewhere in this disclosure, source device 210 may determine, based on a frame height, a frame width, and/or a color component format, whether full-screen playback of the video content is occurring or about to occur. In some examples, source device 210 determines, based on a stored value of a variable that indicates whether a wireless display session is occurring, whether a wireless display session is occurring.

Responsive to source device 210 determining that a mode change event has occurred during the wireless display session (“YES” branch of 508), source device 210 may change from the dual update mode to an external-only update mode during the wireless display session (510). The change may be automatic. Otherwise (“NO” branches of 508), source device 210 may continue generating the primary stream (504) and the external stream (506).

Based on source device 210 operating in the external-only update mode during the wireless display session, source device 210 discontinues generation of the primary stream such that primary display device 218 refreshes content displayed on primary display device 218 from pixel data stored in a memory (e.g., panel memory 240) included in primary display device 218 (512). In examples where full-screen playback of video content is occurring, discontinuing the primary stream may result in the full-screen playback of the video content stopping on primary display device 218. Thus, because primary display device 218 operates in the command mode, while source device 210 is operating in the external-only update mode, primary display device 218 may refresh content displayed on primary display device 218 from pixel data stored in panel memory 240 included in primary display device 218. Furthermore, based on source device 210 operating in the external-only update mode during the wireless display session, source device 210 continues generation of the external stream (514). Thus, in examples where full-screen playback of video content is occurring, the full-screen playback of the video content may continue on external display device 219 device while the full-screen playback of the video content is stopped on primary display device 218. Thus, source device 210 may continue to send sets of pixel data to external display device 219 for each refresh cycle.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can include RAM, ROM, EEPROM, CD-ROM or other optical disk storage, magnetic disk storage or other magnetic storage devices, cache memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” and “processing unit,” as used herein may refer to any of the foregoing structure or any other structure suitable for implementation on of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements. In this disclosure, the phase “based on” may indicate “based at least in part on.”

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other embodiments are within the scope of the following claims.

What is claimed is:

1. A method for controlling streams of pixel data, the method comprising:
initiating, by a source device associated with a primary display device, a wireless display session with an external display device;
during the wireless display session, operating, by the source device, in a dual update mode;
based on the source device operating in the dual update mode during the wireless display session:
generating, by the source device, a primary stream of pixel data for display on the primary display device; and
generating, by the source device, an external stream of pixel data for display on the external display device;
changing, by the source device, from the dual update mode to an external-only update mode during the wireless display session; and
based on the source device operating in the external-only update mode during the wireless display session:
discontinuing, by the source device, generation of the primary stream such that the primary display device refreshes content displayed on the primary display device from pixel data stored in a memory included in the primary display device; and
continuing, by the source device, generation of the external stream.

2. The method of claim 1, further comprising:
in response to detecting a first toggle gesture while the source device is operating in the external-only update mode during the wireless display session, changing, by the source device, from the external-only update mode to the dual update mode, wherein based on the source device changing from the external-only update mode to the dual update mode, resuming, by the source device, generation of the primary stream; and
in response to detecting a second toggle gesture while the source device is operating in the dual update mode, changing, by the source device, from the dual update mode to the external-only update mode.

3. The method of claim 1, wherein:
the source device comprises a display processor having a primary display control path and an external display control path, and
while the source device is operating in the dual update mode:
controlling, by the primary display control path, the display processor such that the display processor generates the primary stream; and
controlling, by the external display control path, the display processor such that the display processor generates the external stream, and
while the source device is operating in the external-only update mode:
disabling the primary display control path such that the display processor stops generating the primary stream; and
continuing, by the external display control path, to control the display processor such that the display processor generates the external stream.

4. The method of claim 3, further comprising:
storing, by the source device, for display during a first refresh cycle, uncomposited pixel data into a frame buffer of a first layer and into a frame buffer of a second layer, wherein the frame buffer of the first layer and the frame buffer of the second layer are in a memory of the source device;
identifying, by the source device, for display during the first refresh cycle, a first set of layers and a second set of layers, wherein the first set of layers includes at least the first layer and the second set of layers includes at least the second layer; and
based on the source device operating in the dual update mode:
controlling, by the primary display control path, the display processor such that the display processor generates a first set of composited pixel data in the primary stream based on the first set of layers, the first set of composited pixel data being for display in the first refresh cycle,
sending, by a primary interface, to the primary display device, the first set of composited pixel data;
controlling, by the external display control path, the display processor such that the display processor generates a second set of composited pixel data in the external stream based on the second set of layers, the second set of composited pixel data being for display in the first refresh cycle; and
sending, by an external interface of the source device, to the external display device, the second set of composited pixel data.

5. The method of claim 4, wherein the method further comprises:
storing, by the source device, for display during a second refresh cycle of the primary display device, second pixel data into the frame buffer of the first layer and the frame buffer of the second layer;
identifying, by the source device, for display during the second refresh cycle, a third set of layers and a fourth set of layers, wherein the third set of layers includes at least the first layer and the fourth set of layers includes at least the second layer; and
based on the source device operating in the external-only update mode:
disabling, by the source device, the primary display control path such that the source device generates in the primary stream no pixel data for display in the second refresh cycle;
controlling, by the external display control path, the display processor such that the display processor generates a third set of composited pixel data based on the fourth set of layers, the third set of composited pixel data being for display in the second refresh cycle; and
sending, by the external interface, to the external display device, the third set of composited pixel data.

6. The method of claim 1, wherein changing from the dual update mode to the external-only update mode is in response to the source device determining that full-screen playback of video content is occurring or is about to occur on the primary display device and the external display device during the wireless display session.

7. The method of claim 6, further comprising:
determining, by the source device, based on a frame height, a frame width, and a color component format, whether full-screen playback of the video content is occurring or about to occur.

8. A source device comprising:
a transceiver; and
one or more processing units configured to:
initiate a wireless display session with an external display device;
during the wireless display session, operate in a dual update mode;
based on the source device operating in the dual update mode during the wireless display session:
generate a primary stream of pixel data for display on a primary display device;
generate an external stream of pixel data for display on the external display device; and
send the external stream to the external display device via the transceiver;
change the source device from the dual update mode to an external-only update mode during the wireless display session; and
based on the source device operating in the external-only update mode:
discontinue generation of the primary stream such that the primary display device refreshes content displayed on the primary display device from pixel data stored in a memory included in the primary display device; and
continue generation of the external stream.

9. The source device of claim 8, wherein the one or more processing units are configured to:
in response to the source device detecting a first toggle gesture while the source device is operating in the external-only update mode during the wireless display session, change the source device from the external-only update mode to the dual update mode, wherein based on the source device changing from the external-only update mode to the dual update mode, the one or more processors resume generation of the primary stream; and
in response to the source device detecting a second toggle gesture while the source device is operating in the dual update mode, change the source device from the dual update mode to the external-only update mode.

10. The source device of claim 8, wherein the one or more processing units comprise a display processor having a primary display control path and an external display control path, and
while the source device is operating in the dual update mode:
the primary display control path controls the display processor such that the display processor generates the primary stream; and
the external display control path controls the display processor such that the display processor generates the external stream, and
while the source device is operating in the external-only update mode:
the primary display control path is disabled such that the primary display control path stops generating the primary stream; and
the external display control path continues to control the display processor such that the display processor generates the external stream.

11. The source device of claim 10, wherein:
the source device further comprises:
a primary interface;
an external interface; and
a memory comprising a frame buffer of a first layer and a frame buffer of a second layer,
the one or more processing units are configured to:
store, for display during a first refresh cycle, uncomposited pixel data into the frame buffer of the first layer and into the frame buffer of the second layer;
identify, for display during the first refresh cycle, a first set of layers and a second set of layers, wherein the first set of layers includes at least the first layer and the second set of layers includes at least the second layer, and based on the source device operating in the dual update mode:
the primary display control path controls the display processor such that the display processor generates a first set of composited pixel data in the primary stream based on the first set of layers, the first set of composited pixel data being for display in the first refresh cycle,
the primary interface sends, to the primary display device, the first set of composited pixel data,
the external display control path controls the display processor such that the display processor generates a second set of composited pixel data in the external stream based on the second set of layers, the second set of composited pixel data being for display in the first refresh cycle, and
the external interface sends, to the external display device, the second set of composited pixel data.

12. The source device of claim 11, wherein:
the one or more processing units are configured to:
store, for display during a second refresh cycle of the primary display device, second pixel data into the frame buffer of the first layer and the frame buffer of the second layer;
identify, for display during the second refresh cycle, a third set of layers and a fourth set of layers, wherein the third set of layers includes at least the first layer and the fourth set of layers includes at least the second layer; and
based on the source device operating in the external-only update mode, disable the primary display control path such that the source device generates in the primary stream no pixel data for display in the second refresh cycle;
based on the source device operating in the external-only update mode, the external display control path controls the display processor such that the display processor generates a third set of composited pixel data in the external stream based on the fourth set of layers, the third set of composited pixel data being for display in the second refresh cycle; and
the external interface sends, to the external display device, the third set of composited pixel data.

13. The source device of claim 8, wherein the one or more processors are configured to change the source device from the dual update mode to the external-only update mode in response to determining that full-screen playback of video content is occurring or about to occur on the primary display device and the external display device during the wireless display session.

14. The source device of claim 13, wherein the one or more processing units are configured to determine, based on a frame height, a frame width, and a color component format, whether full-screen playback of the video content is occurring or about to occur.

15. A computer-readable storage medium having instructions stored thereon that, when executed, cause a source device to:
initiate a wireless display session with an external display device;
during the wireless display session, operate in a dual update mode;
based on the source device operating in the dual update mode during the wireless display session:
generate a primary stream of pixel data for display on a primary display device of the source device; and
generate an external stream of pixel data for display on the external display device;
change the source device from the dual update mode to an external-only update mode during the wireless display session; and
based on the source device operating in the external-only update mode during the wireless display session:
discontinue generation of the primary stream such that the primary display device refreshes content displayed on the primary display device from pixel data stored in a memory included in the primary display device; and
continue generation of the external stream.

16. The computer-readable storage medium of claim 15, wherein execution of the instructions further causes the source device to:
in response to detecting a first toggle gesture while the source device is operating in the external-only update mode during the wireless display session, change the source device from the external-only update mode to the dual update mode, wherein based on the source device changing from the external-only update mode to the dual update mode, execution of the instructions causes the source device to resume generation of the primary stream; and
in response to detecting a second toggle gesture while the source device is operating in the dual update mode, change the source device from the dual update mode to the external-only update mode.

17. The computer-readable storage medium of claim 15, wherein:
the source device comprises a display processor having a primary display control path and an external display control path, and
while the source device is operating in the dual update mode, execution of the instructions causes:
the primary display control path to control the display processor such that the display processor generates the primary stream; and
the primary display control path to control the display processor such that the display processor generates the external stream, and
while the source device is operating in the external-only update mode, execution of the instructions causes:
the source device to disable the primary display control path such that the display processor stops generating the primary stream; and
the external display control path to continue to control the display processor such that the display processor generates the external stream.

18. The computer-readable storage medium of claim 17, wherein execution of the instructions causes:
the source device to store, for display during a first refresh cycle, uncomposited pixel data into a frame buffer of a first layer and into a frame buffer of a second layer, wherein the frame buffer of the first layer and the frame buffer of the second layer are in a memory of the source device;
the source device to identify, for display during the first refresh cycle, a first set of layers and a second set of layers, wherein the first set of layers includes at least the first layer and the second set of layers includes at least the second layer; and
based on the source device operating in the dual update mode:
the primary display control path to control the display processor such that the display processor generates a first set of composited pixel data in the primary stream based on the first set of layers, the first set of composited pixel data being for display in the first refresh cycle,
a primary interface to send to the primary display device, the first set of composited pixel data;
the external display control path to control the display processor such that the display processor generates a second set of composited pixel data in the external stream based on the second set of layers, the second set of composited pixel data being for display in the first refresh cycle; and
an external interface of the source device to send to the external display device, the second set of composited pixel data.

19. The computer-readable storage medium of claim 18, wherein execution of the instructions further causes:
the source device to store, for display during a second refresh cycle of the primary display device, second pixel data into the frame buffer of the first layer and the frame buffer of the second layer;
the source device to identify, for display during the second refresh cycle, a third set of layers and a fourth set of layers, wherein the third set of layers includes at least the first layer and the fourth set of layers includes at least the second layer; and
based on the source device operating in the external-only update mode:
the source device to disable the primary display control path such that the source device generates in the primary stream no pixel data for display in the second refresh cycle;
the external display control path to control the display processor such that the display processor generates a third set of composited pixel data based on the fourth set of layers, the third set of composited pixel data being for display in the second refresh cycle; and
the external interface to send to the external display device, the third set of composited pixel data.

20. The computer-readable storage medium of claim 15, wherein execution of the instructions further causes the source device to change from the dual update mode to the external-only update mode in response to determining that full-screen playback of video content is occurring or is about to occur on the primary display device and the external display device during the wireless display session, changing the source device from the dual update mode to the external-only update mode.
